(19) United States
(12) Patent Application Publication
(10) Pub. No.: US 2007/0222861 A1
(43) Pub. Date: Sep. 27, 2007

(54) Process and program for improving moving picture quality of color display

(76) Inventor: Yoshi Enami, Ritto-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/711,022

(22) Filed: Feb. 27, 2007

(30) Foreign Application Priority Data
Mar. 27, 2006 (JP) 2006-086479

(51) Int. Cl. H04N 7/18; H04N 9/10

(52) U.S. Cl. 348/196; 348/78

(57) ABSTRACT

An image signal corresponding to a moving area of a moving picture is obtained, a color B that has a predetermined relationship with (complementary to) R+G present in color breakup at an edge part of the moving picture corresponding to the obtained image signal is added so as to eliminate the color breakup at the edge part, and then an image signal where the color for eliminating the color breakup at the edge is added is fed to a color display.

### BACKGROUND OF THE INVENTION

1. Field of the Invention

The present invention relates to a method for improving image quality of a color display that displays an image by light emission of display elements of a plurality of colors.

2. Description of Related Art

In order to evaluate the blurriness of a moving picture (also referred to as “moving picture blur”) on a display, measurements need to be made by moving a camera so as to pursue the moving picture like human eyeballs.

There is a known device (which is referred to as “moving picture camera”) for capturing pursued images of a moving picture by rotating a galvanometer scanner provided with a mirror in accordance with the moving speed of the moving picture.

This image capturing device captures pursued images of a picture while the picture is scrolled from left to right. A graph is plotted by converting CCD pixels in the moving direction of the captured image into a time axis as the abscissa, and taking RGB received intensity as the ordinate. The resultant curve is referred to as an MPRC (Moving Picture Response Curve). Based on the edge shape of this MPRC, an MPRT (Moving Picture Response Time) is determined. Objective evaluations of the moving picture blurs can be made using this MPRT.

When a moving picture response curve is obtained as a result of pursuit-capturing a moving picture by a color camera, a coloration phenomenon is observed at the edge part.

It has been known that, in the case of a field sequential drive display for example, in its principles, the light emitting timings for the elements of the respective colors are shifted for each RGB, so that a coloration phenomenon (which is called “color breakup”) occurs at the edge part of the displayed moving picture. This is because the display timings are shifted even though the moving picture response time is the same for each color.

In the cases of plasma displays and liquid crystal displays, color blurring occurs because the moving picture response time varies depending on the color of each display element. For example, in a plasma display, due to the differences in response speed and persistence of a phosphor among RGB colors, a bluish tone appears during a black to white transition, and a yellowish tone appears during a white to black transition. For this reason, color breakup occurs at the moving picture edge part.

While improvements are required in light emitting structure of the display and response speeds of the display elements in order to prevent color breakup at the edge part, such improvements tend to be accompanied with technical difficulties and time consuming.

Therefore, feeding an image signal for preventing color breakup that appears in the moving area of an image to the display can improve color breakup at an edge part of a moving picture with ease and convenience.

It is an object of the present invention to provide a process and a program for improving moving picture quality that can improve color breakup of an edge part of a moving picture with ease and convenience.

### SUMMARY OF THE INVENTION

A process for improving moving picture quality of a color display according to the present invention comprises the steps of: obtaining at least an image signal corresponding to a moving area of an image from image signals for displaying a moving picture on a color display; adding a color for eliminating color breakup at the edge part of the moving picture corresponding to the obtained image signal; and feeding an image signal where the color for eliminating the color breakup at the edge part is added to the color display.

According to the process, it is possible to eliminate color breakup by adding a color for eliminating the color breakup at an edge part of the displayed moving picture. The color for eliminating the color breakup at the edge is, for example, a color complementary to the hue or tint of the color breakup.

In order to find the color for eliminating the edge color breakup, information on the lighting timings of the display is necessary. For example, while an image including an edge is scrolled on the display to be measured, the scrolling image is pursued and captured (pursuit-captured) with a color camera to obtain a pursuit-captured color moving picture image. Based on the pursuit-captured color moving picture image, there are obtained moving picture response curves of the respective colors based on emission light intensity (luminance) of the display elements of the display to be measured. Using these moving picture response curves, the color for eliminating the color breakup at the edge part can be specified.

In the case where the foregoing edge is an edge that temporally moves from an area having a smaller luminance to an area with a greater luminance, the color for eliminating the color breakup at the edge is a color of a display element having a relatively long moving picture response time.

In the case where the foregoing edge is an edge that temporally moves from an area having a greater luminance to an area having a smaller luminance, the color for eliminating the color breakup at the edge is a color of a display element having a relatively short moving picture response time.

In the case of a sequential drive color display adapted to cause display elements of respective colors to emit light sequentially color by color, because of the lighting timings for the display elements of the respective colors are shifted from each other, a colored band appears at the edge part of the moving picture.

When the foregoing edge is an edge that temporally moves from an area having a smaller luminance to an area having a greater luminance, the color for eliminating the color breakup at the edge is a color of a display element that appears relatively late in the order of appearance.

When the foregoing edge is an edge that temporally moves from an area having a greater luminance to an area having a smaller luminance, the color for eliminating the color breakup at the edge is a color of a display element that appears relatively early in the order of appearance.

A program for improving moving picture quality of a color display according to the present invention comprises the steps of: obtaining at least an image signal corresponding to a moving area of an image from image signals for displaying a moving picture on the color display; adding a color for eliminating color breakup at an edge part of the moving image corresponding to the obtained image signal; and feeding an image signal where the color for eliminating the color breakup at the edge is added to the color display. Only providing such a process (application) for improving moving picture quality to an image signal generator enables quantitative evaluations and verifications of the effect of improving moving picture color breakup. Thus, only by connection through an image processing apparatus with this program installed therein to the display, the effect of improving color breakup of moving picture can be achieved, so that the moving picture quality of a color display can be improved very easily and conveniently.

As described above, according to the present invention, a moving picture area and the moving direction are detected on frames before and after an image signal and an improvement signal is added to an edge part of the moving picture area, whereby color blurring of the moving picture can be improved.

While generally, improving such a characteristic requires improvements in the display structure of the color display. However, since this improvement technique only requires processing on an image signal, therefore, no improvements are necessary for the display device. As a result, it is applicable to various kinds of display devices.

These and other advantages, features and effects of the present invention will be made apparent by the following description of preferred embodiments with reference to the accompanying drawings.

### BRIEF DESCRIPTION OF THE DRAWINGS

FIG. 1 is a block diagram illustrating a construction including a moving picture pursuit color camera.

FIG. 2 is a light path diagram illustrating a positional relationship between a detection surface of a camera and a display device to be measured.

FIG. 3(a) is a view illustrating a measurement pattern P moving at a speed vp indicated by an arrow and a field of view corresponding to a camera detection surface moving at a movement speed vc to pursue thereafter.

FIG. 3(b) is a graph showing a luminance distribution of a measurement pattern P detected at the camera detection surface.

FIG. 3 (c) is a graph showing a luminance distribution of the measurement pattern P where an image of the measurement pattern P is captured with a minimum blur.

FIG. 4 is a flowchart illustrating a procedure for determining chromaticity correction coefficient and display chromaticity coefficient.

FIG. 5 is a flowchart illustrating a flow of converting a measurement value of a color camera 3 into a color moving picture response curve using chromaticity, and into a color moving picture response curve using emission intensity of the display elements of the display of measuring object.

FIG. 6 is a photograph showing a pursuit-captured color moving picture image displayed on a plasma display.

FIG. 7 is a photograph showing a pursuit-captured color moving picture image displayed on a plasma display.

FIG. 8 is a graph showing color moving picture response curves using emission light intensity (luminance) of a display.

FIG. 9 is a graph showing color moving picture response curves using emission light intensity (luminance) of a display.

FIG. 10 is a photograph of a pursuit-captured color moving picture image after improvement.

FIG. 11 is a graph showing color moving picture response curves using emission light intensity (luminance) of a display.

FIG. 12 is a photograph of a pursuit-captured color moving picture image after improvement.

FIG. 13 is a graph showing color moving picture response curves using emission light intensity (luminance) of a display.

FIG. 14 is a photograph of a pursuit-captured color moving picture image displayed on a field sequential display.

FIG. 15 is a photograph of a pursuit-captured color moving picture image displayed on a field sequential display.

FIG. 16 is a graph showing color moving picture response curves using emission light intensity (luminance) of a display.

FIG. 17 is a graph showing color moving picture response curves using emission light intensity (luminance) of a display.

FIG. 18 is a photograph of a pursuit-captured color moving picture image after improvement.

FIG. 19 is a graph showing color moving picture response curves using emission light intensity (luminance) of a display.

FIG. 20 is a photograph of a pursuit-captured color moving picture image after improvement.

FIG. 21 is a graph showing color moving picture response curves using emission light intensity (luminance) of a display.

FIG. 22 is a block diagram showing an image display system to which a program for improving moving picture quality according to the present invention is applied.

### DETAILED DESCRIPTION OF PREFERRED EMBODIMENTS

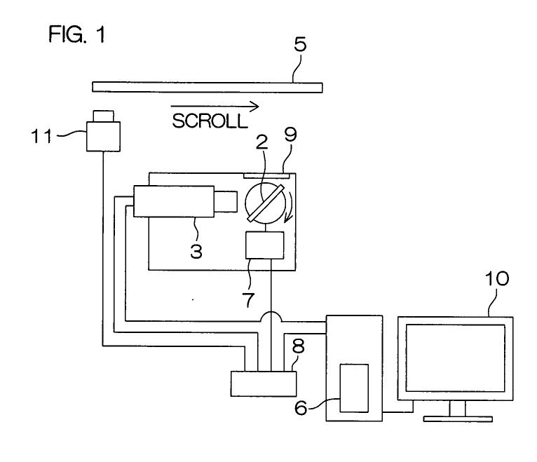

FIG. 1 is a schematic structural diagram including a moving picture color camera.

The moving picture pursuit color camera photographs the screen of a display 5 to be measured, which includes a galvanometer mirror 2, a color camera 3 for photographing the display 5 through the galvanometer mirror 2, a photosensor 11 and a computer control section 6.

The galvanometer mirror 2 includes a permanent magnet disposed rotatably in a magnetic field that is generated by applying electric current to a coil, and is capable of rotating smoothly and rapidly.

A rotation drive signal is transmitted from the computer control section 6 to the galvanometer mirror 2 through a galvanometer mirror drive controller 7.

Instead of providing the galvanometer mirror 2 and the color camera 3 separately, a camera such as a light-weight digital camera may be disposed on a spin base so as to be rotationally driven by a rotational drive motor.

The color camera 3 has a field of view including a part of or the entire display 5.

A luminous efficiency film 9 and the galvanometer mirror 2 are present between the color camera 3 and the display 5 so that the field of view of the color camera 3 can move in one dimensional direction (hereinafter referred to as “scroll direction”) on the display 5 in response to the rotation of the galvanometer mirror 2.

The photosensor 11 detects an image moving on the display 5, and the rotation of the galvanometer mirror 2 is triggered to start at the time of detection by the photosensor 11. The photosensor 11 may be spared, and in that case, a trigger signal that states the rotation of the galvanometer mirror 2 may be transmitted from the computer control section 6 to the galvanometer mirror drive controller 7.

Image signals obtained from the color camera 3 are taken into the computer control section 6 through I/O board 8.

A liquid crystal monitor 10 is connected to the computer control section 6.

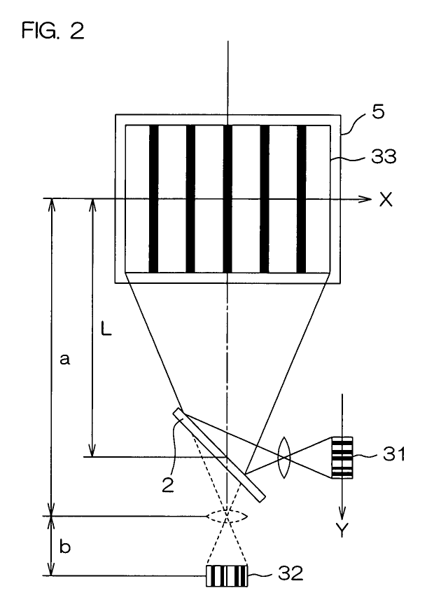

FIG. 2 is a light path diagram illustrating the positional relationship between a detection surface 31 of the color camera 3 and the display 5 to be measured. Light rays from the display 5 are reflected by the galvanometer mirror 2 to be incident on the lens of the color camera 3 and detected at the detection surface 31 of the color camera 3. A mirror image 32 of the detection surface 31 of the color camera 3 is drawn in broken lines on the rear side of the galvanometer mirror 2.

Let the distance along the optical path between the display 5 and the galvanometer mirror 2 be represented by L, the distance along the optical path between the display 5 and the lens be represented by a, and the distance along the optical path between the lens and the detection surface 31 be represented by b. When the focal distance f of the lens is given, the relationship between a and b can be determined using the following equation:
1/f=1/a+1/b

Assume that a coordinate of the screen 5 of the display device to be measured in the scrolling direction is X, and that a coordinate in terms of received light intensity of the detector plane 31 of the color camera 3 is Y. Set X0, the origin of X, at the center of the screen of the display to be measured, and set Y0, the origin of Y, at the point corresponding to X0. If the magnification of the lens of the camera 3 is M,
X=MY
is satisfied. The magnification M is expressed using the aforesaid a and b as follows:
M=−b/a

If the galvanometer mirror 2 is rotated by an angle φ, the corresponding position on the display 5 to be measured deviates with respect to the rotation axis of the galvanometer mirror 2 by an angle of 2φ. The coordinate X on the display 5 to be measured that corresponds to the angle 2φ is expressed as follows:
X=L tan 2φ

A modification of the equation above gives the following equation:
Φ=arctan(X/L)/2

The equation [X=L tan 2φ] is differentiated by time to give the following equation:
v=2Lω cos⁻²(2φ)
where v represents movement speed of the field of view 33 on the display, and ω represents rotation viewing angular speed of the galvanometer mirror (ω=dφ/dt). If φ is a minute angle, cos²(2φ)→1 can be assumed, therefore the equation above can be expressed as:
ω=v/2L

Thus, it can be assumed that the movement speed v of the field of view 33 on the display is proportional to the rotation viewing angular speed ω of the galvanometer mirror 2.

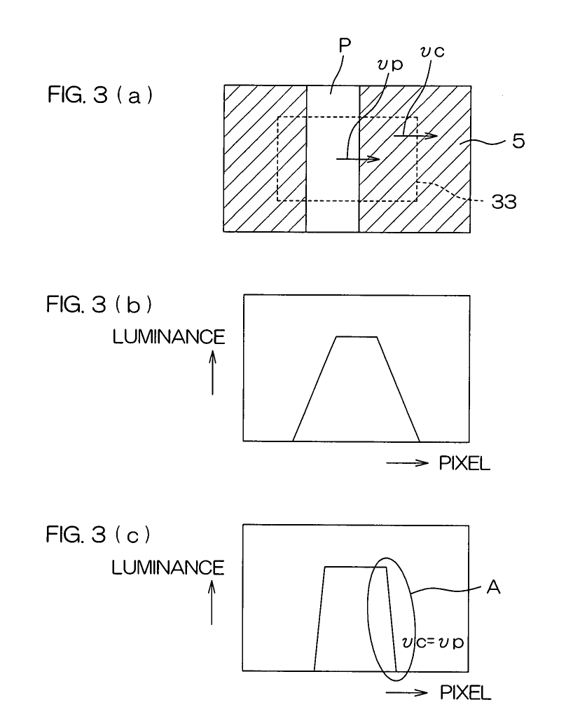

Now, referring to FIGS. 3(a)-3(c), the principles of a method of evaluating a display will be described.

Suppose that a measurement pattern P for evaluation is a band-like measurement pattern P having a luminance brighter than the background and extends in the scroll direction over a predetermined length. When the galvanometer mirror 2 is rotated at a viewing angular speed corresponding to the movement of the measurement pattern P on the display 5 to be measured, an image of the measurement pattern P is captured by the color camera 3. However, note that the shutter of the color camera 3 is kept open during the rotation of the galvanometer mirror 2.

FIG. 3(a) is a view illustrating a measurement pattern P moving at a speed vp indicated by an arrow and a field of view 33 corresponding to the camera detection surface 31 moving at a movement speed vc to pursue thereafter.

Receiving light intensity distributions of images detected at the camera detection surface 31 are as shown in FIGS. 3(b) and 3(c). The abscissa in FIG. 3(a), 3(b) represents pixel aligned along the scroll direction, and the ordinate represents received light intensity.

FIG. 3(b) shows an image of the measuring pattern P when the movement speed vc of the field of view 33 does not correspond to the movement speed vp of the measuring pattern P.

When the rotation viewing angular speed of the galvanometer mirror 2 is represented by ω and the rotation viewing angular speed corresponding to the movement speed vp of the measurement pattern P is designated as ω 0, the movement speed vc of the field of view 33 equals to the movement speed vp of the measurement pattern P. FIG. 3(c) shows an image of the measurement pattern P when the movement speed vc of the field of view 33 corresponds to the movement speed vp of the measurement pattern P.

Next, the relationship between a moving picture response curve (MPRC) and a moving picture response time (MPRT) will be described.

The received light intensity distribution of the image of the measurement pattern P detected by the camera detection surface 31 as described above (FIG. 3(b), FIG. 3(c)) is defined as the moving picture response curve MPRC. A coordinate in pixel of the color camera 3 is expressed y as described above.

Simply stated, the moving picture response time (MPRC) is a curve obtained by converting the abscissa y of the moving picture response curve (MPRC) into time axis.

Where the ratio of the number of pixels of the display 5 of the target display to the number of pixels of the camera detection surface 31 corresponding to the display 5 is defined as R, the ratio R is represented by:
R=(Pi_{PDP}/Pi_{CCD})M_{OPT}
wherein the subscript “PDP” indicates the target display (the target display is not limited to the PDP in the present invention), and the subscript “CCD” indicates the detection surface of the camera (the camera is not limited to the CCD in the present invention) Further, Pi_{PDP} is the pixel pitch of the target display, Pi_{CCD} is the pixel pitch of the detection surface of the color camera 3, and M_{OPT} is the magnification of the camera 3 (M_{OPT} is equal to the magnification M described above).

A relationship between the coordinate XPDP on the target display 5 and the pixel coordinate y of the camera 3 (obtained by converting the coordinate Y on the detection surface of the camera 3 into the number of pixels) is represented by:
X_{PDP}=(Pi_{PDP}/R)y

The viewing angle θ of the coordinate X_{PDP} is represented by:
θ=arctan(X_{PDP}/a)
where a is the distance between the target display and the lens as described above.

Where a viewing angular speed on the target display 5 is defined as Vθ, a relationship between the viewing angular speed Vθ and a speed (dy/dt) along the pixels on the detection surface of the color camera 3 is represented by:
Vθ=dθ/dt=(1/a)(dX_{PDP}/dt)=(Pi_{PDP}/aR)dy/dt

However, this equation is an approximate expression when a is sufficiently great. Where the viewing angular speed Vθ is constant, the number of pixels on the detection surface of the color camera 3 and the time can be correlated with each other by this equation. Where a change in the number of pixels on the detection surface of the color camera 3 is defined as Δy and a change in time is defined as Δt, the following equation is established:
Δy=(aRVθ/Pi_{PDP})Δt

With this equation, the blur of the image on the detection surface of the camera 3 can be converted into a time span. Therefore, a curve resulting from conversion of the abscissa y of the moving picture response curve (MPRC) which is the luminance distribution of the image of the measurement pattern P detected by the camera detection surface 31 into the time t, that is, a moving picture response time (MPRT) can be obtained.

Next, the principles of the process for obtaining a color moving picture response curve according to the present invention are discussed.

A pursuit-captured color moving picture is an image that two dimensionally shows intensity of received light (referred to as “RGB received light intensity” in this specification) that transmits through RGB filters of the installed color camera 3 and is detected by sensor pixel.

The first attempt is to convert the RGB received light intensity of an image detected by the color camera 3 into chromaticity. The conversion equation is as follows:

$$[ \begin{matrix}KXR & KXG & KXB \\ KYR & KYG & KYB \\ KZR & KZG & KZB\end{matrix} ] * [ \begin{matrix}CCDR \\ CCDG \\ CCDB\end{matrix} ] = [ \begin{matrix}CCDX \\ CCDY \\ CCDZ\end{matrix} ] \qquad [ eq . 1 ]$$

where the following [eq. 2] represents “chromaticity correction coefficients” for converting RGB received light intensity of the respective RGB color filters of the color camera 3 into chromaticity.

$$[ \begin{matrix}KXR & KXG & KXB \\ KYR & KYG & KYB \\ KZR & KZG & KZB\end{matrix} ] \qquad [ eq . 2 ]$$

The following [eq. 3] represents intensity values of RGB received light transmitting through the RGB filters of the color camera 3.

$$[ \begin{matrix}CCDR \\ CCDG \\ CCDB\end{matrix} ] \qquad [ eq . 3 ]$$

The following [eq. 4] represents chromaticity obtained from the color camera 3.

$$[ \begin{matrix}CCDX \\ CCDY \\ CCDZ\end{matrix} ] \qquad [ eq . 4 ]$$

According to eq. 1, the chromaticity of the target display (eq. 4) can be determined from the chromaticity correction coefficients (eq. 2) and the RGB received light intensity (eq. 3). While the chromaticity (eq. 4) is expressed using XYZ, it is also possible to convert from XYZ into chromaticity parameters such as Y, x, y or L, u′, v′ or the like.

The foregoing chromaticity correction coefficients (eq. 2) is required to be determined previously.

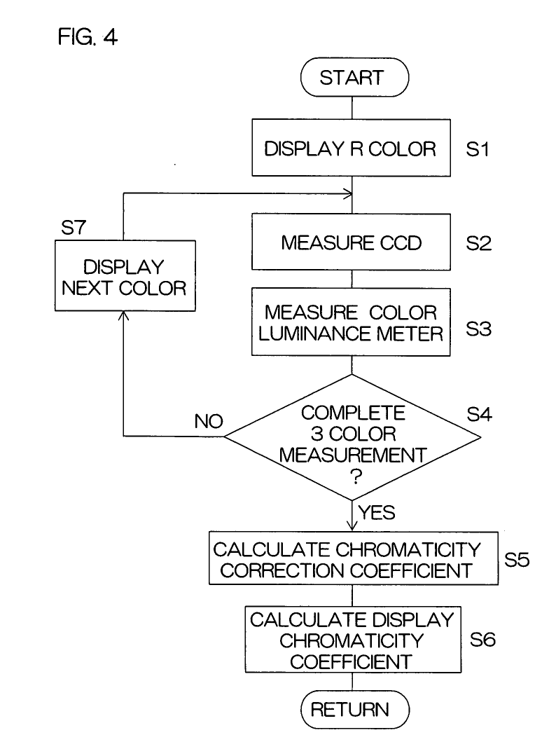

The procedure for determining this chromaticity correction coefficient is now described referring to a flowchart (FIG. 4).

To determine a chromaticity correction coefficient, R color is displayed on a display (Step S1), an RGB received light intensity is measured by a color camera 3 and a measurement value is written as CCDRr, CCDGr, and CCDBr (Step S2).

Then, a chromaticity of X, Y, Z on the R color display are measured by a color luminance meter, and the resulting measurement is written as SXr, SYr, SZr (Step S3).

As well as in G color display on the display, CCD measurement CCDRg, CCDGg, CCDBg, and chromaticity measurement SXg, SYg, SZg measured with the color luminance meter are determined in the same way as above.

As well as in B color display on the display, also CCD measurement CCDRb, CCDGb, CCDBb, and chromaticity measurement SXb, SYb, SZb measured with the color luminance meter are determined in the same way.

As a result, the following simultaneous equations with three unknowns are established:

$$\begin{matrix}[ \begin{matrix}KXR & KXG & KXB \\ KYR & KYG & KYB \\ KZR & KZG & KZB\end{matrix} ] * [ \begin{matrix}CCDRr \\ CCDGr \\ CCDBr\end{matrix} ] = [ \begin{matrix}SXr \\ SYr \\ SZr\end{matrix} ] & [ eq . 5 ] \\ [ \begin{matrix}KXR & KXG & KXB \\ KYR & KYG & KYB \\ KZR & KZG & KZB\end{matrix} ] * [ \begin{matrix}CCDRg \\ CCDGg \\ CCDBg\end{matrix} ] = [ \begin{matrix}SXg \\ SYg \\ SZg\end{matrix} ] & [ eq . 6 ] \\ [ \begin{matrix}KXR & KXG & KXB \\ KYR & KYG & KYB \\ KZR & KZG & KZB\end{matrix} ] * [ \begin{matrix}CCDRb \\ CCDGb \\ CCDBb\end{matrix} ] = [ \begin{matrix}SXb \\ SYb \\ SZb\end{matrix} ] & [ eq . 7 ]\end{matrix}$$

Solving these three simultaneous equations gives chromaticity correction coefficients (eq. 2) including nine unknowns (Step S5).

At this time, the matrix (eq. 9) that consists of actual measurement values SXr, SYr, SZr, SXg, SYg, SZg, SXb, SYb, SZb for single color display measured by the color luminance meter used in determining the foregoing chromaticity correction coefficient is stored (Step S6). This matrix is referred to as “display chromaticity coefficient”.

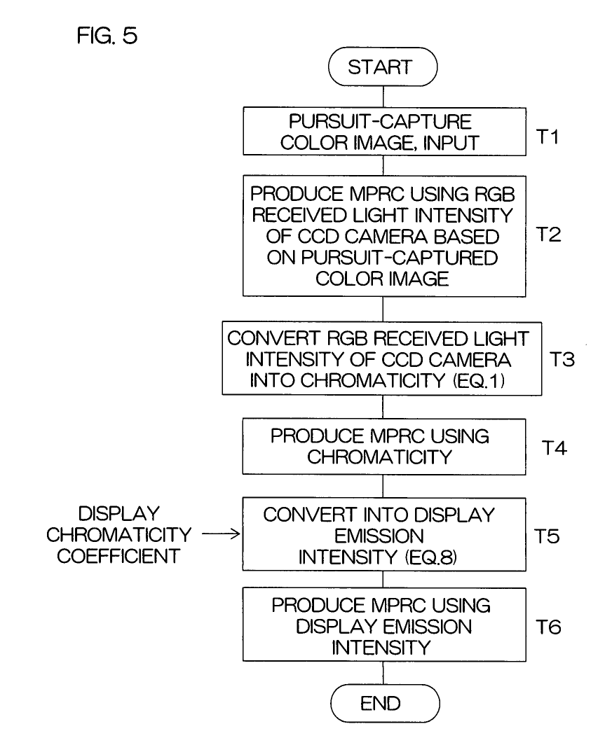

FIG. 5 is a flowchart illustrating a method for converting the RGB received light intensity measured by the color camera 3 into emission intensity of display elements of the target display.

A scrolling image displayed on the display is pursued by the galvanometer scanner, and the photosensor detects a measurement timing, upon which the color camera 3 pursuit-captures the image. This image is referred to as “pursuit-captured color image”. The image data is input into the computer control section 6 (Step T1).

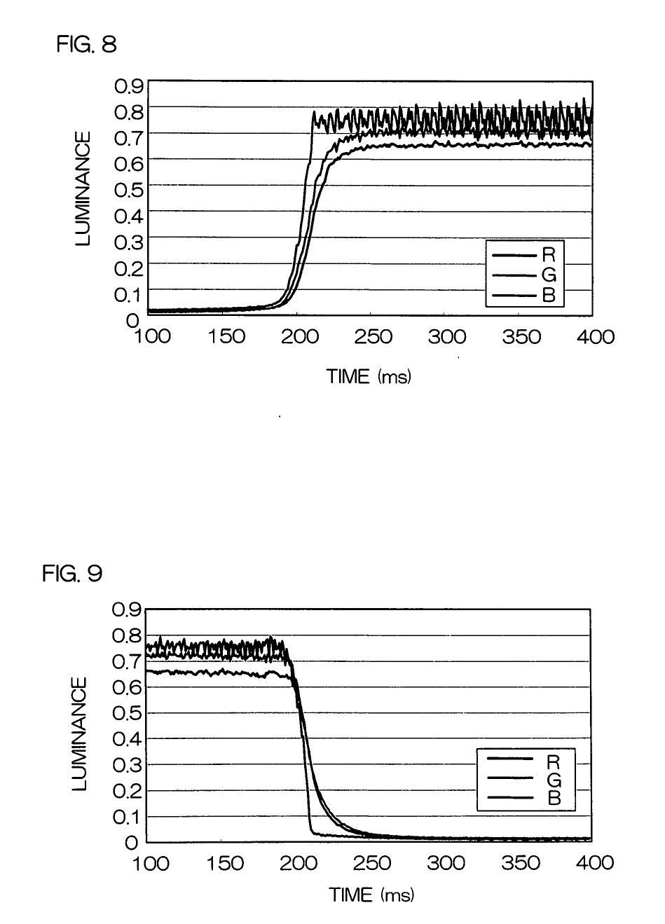

Based on the RGB received light intensity data, color moving picture response curves (FIG. 8) are produced (Step T2).

Subsequently, the RGB received light intensity data are converted into chromaticity using the conversion equation (eq. 1) (Step T3). Thus, the chromaticity CCDX, CCDY, CCDZ can be determined from the measurement value of the RGB received light intensity of the color camera 3.

Color moving picture response curves using the chromaticity are drawn (Step T4).

On the other hand, the chromaticity CCDX, CCDY, CCDZ obtained from the color camera 3 are converted into RGB emission intensity of the target display (Step T5).

Since the transmittance of the color filter provided in the CCD is not adapted for single color of RGB of the display, a color moving picture response curve of a color camera is different from an emission intensity response curve of the display. For example, since Green in a color camera has a wide band for transmissive wavelength, the color includes a mixture of not only G of the display, but also R and B components. For this reason, the emission intensity is different from that of G of the display, which makes it difficult to adjust the timing.

This conversion equation is expressed as follows:

$$[ \begin{matrix}SXr & SXg & SXb \\ SYr & SYg & SYb \\ SZr & SZg & SZb\end{matrix} ] * [ \begin{matrix}DisplayR \\ DisplayG \\ DisplayB\end{matrix} ] = [ \begin{matrix}CCDX \\ CCDY \\ CCDZ\end{matrix} ] \qquad [ eq . 8 ]$$

where [eq. 9] expressed as follows represents the foregoing display chromaticity coefficients;

$$[ \begin{matrix}SXr & SXg & SXb \\ SYr & SYg & SYb \\ SZr & SZg & SZb\end{matrix} ] \qquad [ eq . 9 ]$$

[eq. 10] expressed as follows represents display emission intensity to be determined;

$$[ \begin{matrix}DisplayR \\ DisplayG \\ DisplayB\end{matrix} ] \qquad [ eq . 10 ]$$

and [eq. 11] expressed as follows represents chromaticity calculated using the conversion equation (eq. 1) based on the measurement of the color camera 3.

$$[ \begin{matrix}CCDX \\ CCDY \\ CCDZ\end{matrix} ] \qquad [ eq . 11 ]$$

When the conversion equation (eq. 8) is solved, the emission intensity of the RGB display elements (eq. 10) can be determined based on the chromaticity CCDX, CCDY, CCDZ obtained from the color camera 3.

Based on the emission light intensity (luminance) of the display elements of the display, color moving picture response curves are produced (Step T6).

Through this procedure, the measurement values of the color camera 3 are converted into emission intensity of the display elements of the target display, by which color moving picture response curves using the emission intensity of the display elements of the target display can be obtained.

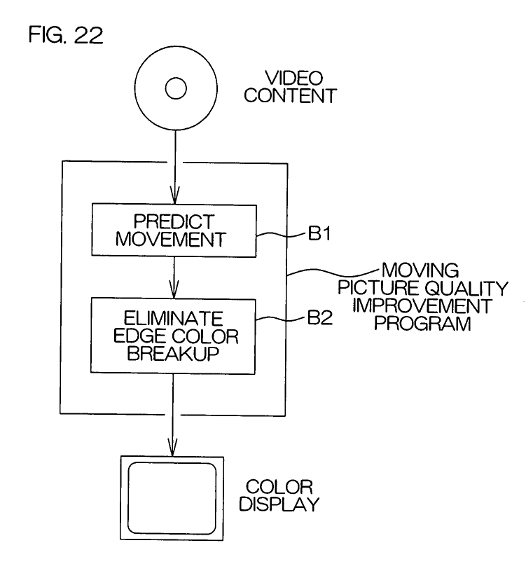

FIG. 22 is a block diagram showing an image display system to which a program for improving moving picture quality according to the present invention is applied. After image signals from image storing media and video content of broadcast sources are processed through a program for improving moving picture quality according to the present invention, the image signals are input into a color display device having a built-in image display function to be displayed thereon.

The program for improving moving picture quality is a program for implementing a process for improving moving picture quality according to the present invention, which is stored in a predetermined medium such as a CD-ROM or a hard disc and executed by a computer.

Hereinafter, a process for improving moving picture quality of a color display according to the present invention will be described.

The process for improving moving picture quality is for converting an image signal fed to a color display into an image signal where a color for improving color breakup in the moving direction of a displayed moving picture is added.

In order to implement the process, it is first necessary to obtain at least an image signal corresponding to a moving area of a moving picture from image signals for displaying the moving picture on the color display (Refer to B1 in FIG. 22).

For this reason, it is necessary to predict the position in the image which is on the move (this is referred to as “movement prediction”). A known technique, namely, the block matching method, spatial hierarchical correlation method, gradient method, phase correlation or the like is employed (John Watkinson: “The Engineer's Guide to Motion Compensation.” KENROKUKAN PUBLISHING CORPORATION, 15 Nov., 2000).

In the block matching method, a block is compared by pixel, with an identical sized block in an identical place in the next image. If no motion is found between fields, a high correlation exists between the pixel values. However, in the case where a motion is found, such correlation must appear at a block at another location. Therefore, a search is carried out with a change of the block, and the location which gives the best correlation is assumed as a new location of the moving edge.

In the gradient method, the relationship between distance from the screen and the brightness at some point in an image has an incline, known as a spatial luminance gradient. Finding the incline can predict the motion.

In the phase correlation method, a spectral analysis is carried out in two successive fields and then all of the phases of the spectral components are subtracted. The phase differences are then subject to a reverse transform which directly reveals a peak correspond to a motion between the fields.

In this way, the moving direction of the moving picture and the gradation the portion are detected. Then, the portion is decomposed into a group of a plurality of edges.

The colors of the edges are detected, then subjected to coloring for eliminating the colors of the edges. The coloring allows moving picture response curves of the respective colors of the edges to be coincident with one another, so that the color blurring is eliminated (See B2 in FIG. 22).

Hereinafter, descriptions will be given for a plasma display and a DLP display, respectively.

(1) Plasma Display

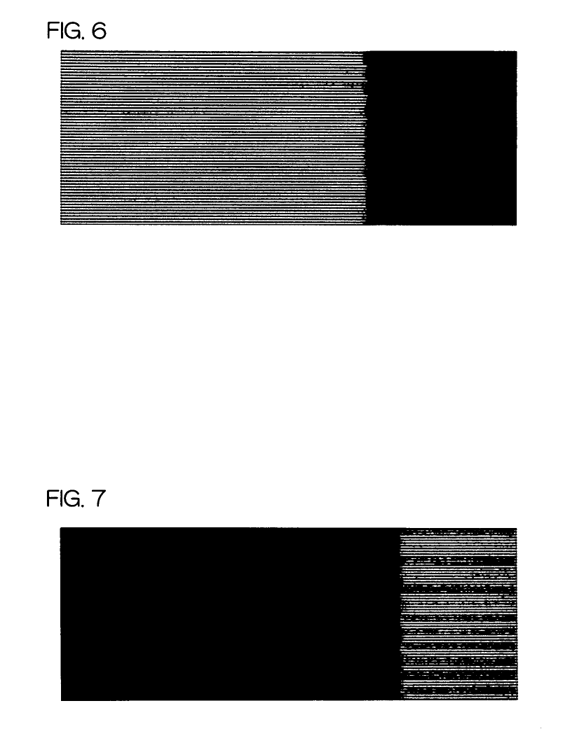

FIG. 6 is a pursuit-captured color moving picture image of an edge that temporally moves from black to white displayed on a plasma display, and FIG. 7 is a pursuit-captured color moving picture image of an edge that temporally moves from white to black displayed on the plasma display. The measurement conditions are as follows:

| | |
|---|---|
| Sample: | plasma display |
| Edge Image Scroll speed: | 8 pixel/frame |
| Camera shutter speed: | 1/20 sec |
| Image signal: | 720P (progressive) |

Moving picture response curves using emission light intensities (luminances) of the display elements of the respective colors of the plasma display are shown in FIGS. 8 and 9. The pattern of FIG. 8 can be obtained when the edge with white on the left and black on the right as shown in FIG. 6 scrolls left to right, and the pattern of FIG. 9 can be obtained when the edge with black on the left and white on the right as shown in FIG. 7 scrolls left to right.

During the transition process from black to white, the edge has a bluish hue because of the quick response speed of the blue element. FIG. 6 shows this phenomenon in a visual form and FIG. 8 shows this by a graph.

During the transition process from white to black, because of the quick response speed of the blue element, the complementary color thereof (yellow) remains, which gives the edge an yellowish hue. FIG. 7 shows the phenomenon in a visual form and FIG. 9 shows the same in a graph.

Therefore, in order to improve the color blurring at the edge part, display timings for the respective display colors are made coincident.

In the case of an edge moving from black to white in FIG. 8, color blurring in the moving picture can be improved by accelerating the display timings of display colors other than blue. That is, when the display timings of red and green are accelerated, the bluish hue at the edge displayed in a moving state on the plasma display disappears. Alternatively, instead of accelerating the display timings of red and green, red and green lines may be added between white and black with respect to the moving direction.

Accordingly, by adding edges of the colors of elements having long response times to the edge part of the image of the moving picture, the response timings of red, blue and green coincide when the image is scrolled. As a result, the color blurring is improved.

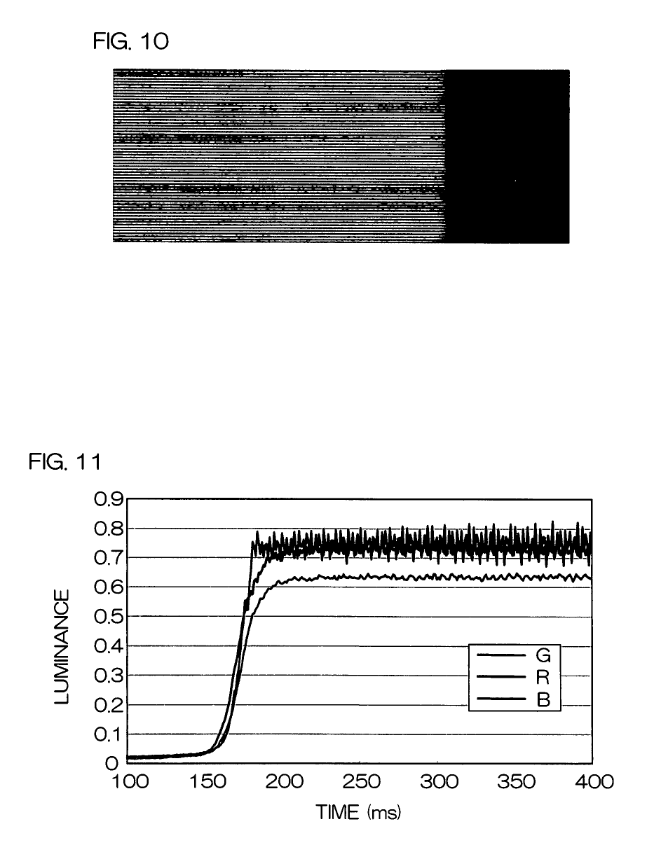

FIG. 10 shows a pursuit-captured color moving picture image obtained as a result of feeding an image signal where the display timings of red and green display elements are accelerated (or red and green display colors are added to the plasma display). FIG. 11 shows moving picture response curves using emission light intensity (luminance). When compared with FIG. 8, the rising speeds of the three colors are almost identical, and as a result, the responses of RGB are coincident with one another. Accordingly, the bluish color blurring of the edge is eliminated, thereby realizing a black-to-white transition.

In addition, in the display of an edge moving from white to black shown in FIG. 9, color blurring of the moving picture can be improved by delaying the response timing of the blue display color. That is, because of the delayed display timing of blue, the edge displayed in a moving state on the plasma display loses the yellowish hue. Alternatively, instead of delaying the display timing of blue, blue lines may be added between white and black with respect to the moving direction.

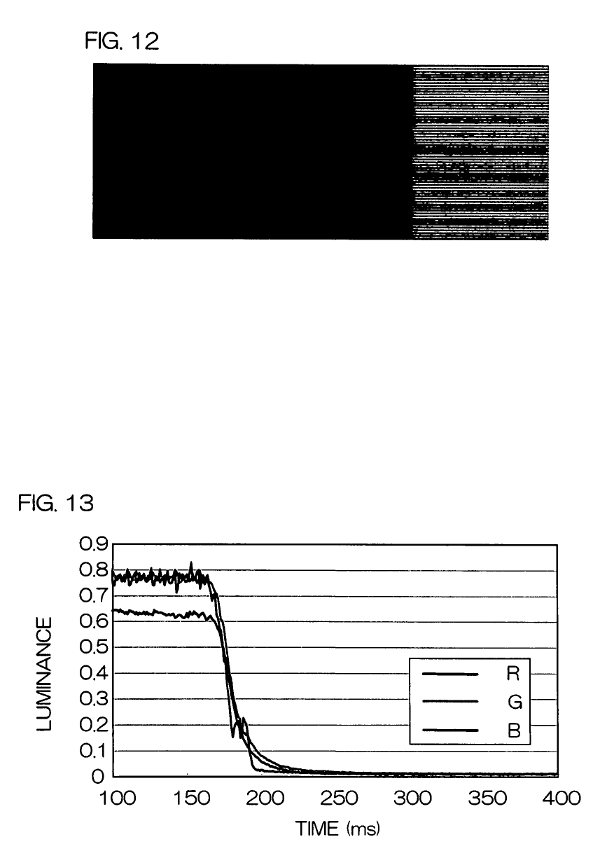

FIG. 12 shows a pursuit-captured color moving picture image obtained by feeding an image signal where the display timing of blue display color is delayed (or blue display color is added) to the plasma display. FIG. 13 shows moving picture response curves using emission light intensity (luminance). The comparison with FIG. 9 shows that the curves of the three colors start dropping with almost identical inclination; therefore, color blurring does not occur.

The technique is applicable to displays other than plasma displays, such as liquid crystal displays.

(2) Field Sequential Drive Display

In the case of a field sequential drive display, the display timings of RGB are shifted from one another based on its principles. The shifted timings do not cause annoyance on a still image by virtue of persistence effect of human vision. However, in the case of a moving picture display where the moving direction is converted into a time axis, step-like color breakup occurs at the edge part.

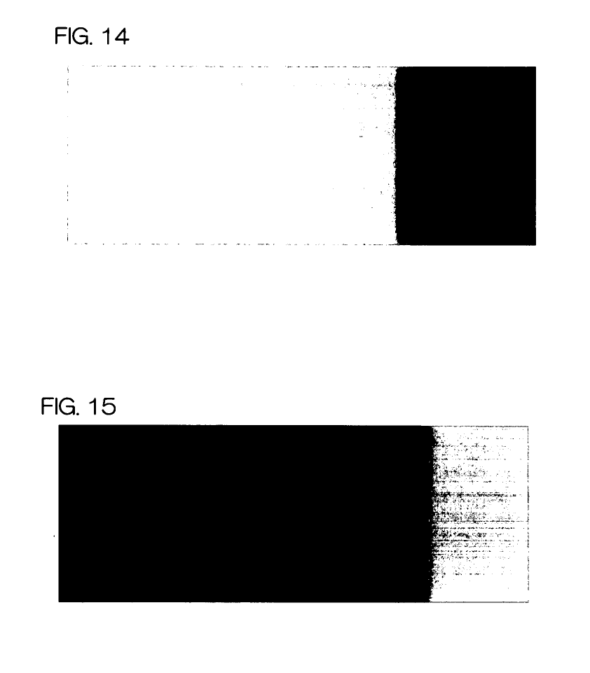

FIG. 14 is a pursuit-captured color moving picture image of an edge that temporally moves from black to white_displayed on a display, and FIG. 15 is a pursuit-captured color moving picture image of an edge that temporally moves from white to black displayed on a plasma display. The measurement conditions are as follows:

| | |
|---|---|
| Sample: | field sequential drive display |
| Edge Image Scroll Speed: | 8 pixel/frame |
| Camera shutter speed: | 1/20 sec |
| Image signal: | 720P (progressive) |

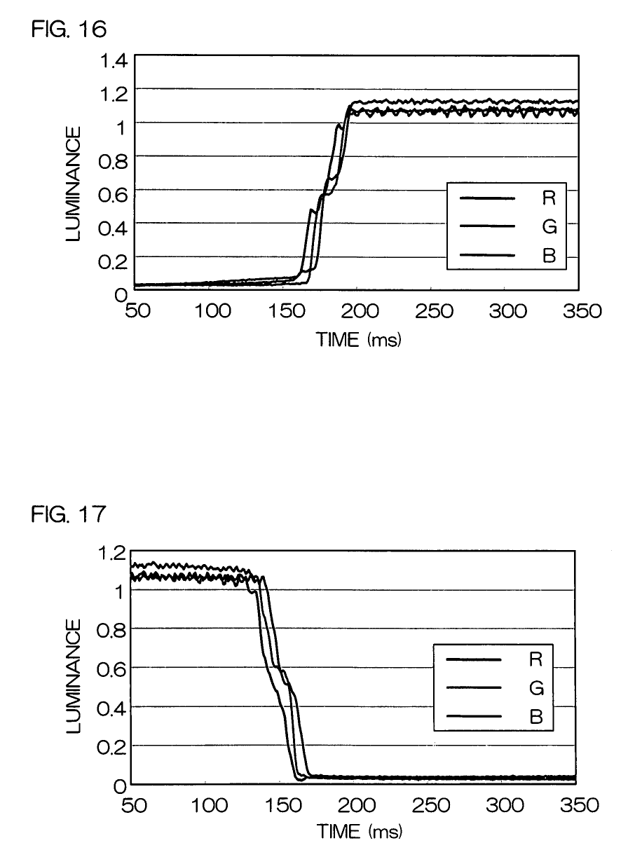

Moving picture response curves using emission light intensity (luminance) of the respective color elements of DLP are shown in FIGS. 16 and 17. The pattern of FIG. 16 can be obtained when an edge with white on the left and black on the right as shown in FIG. 14 scrolls left to right, and the pattern of FIG. 17 can be obtained when an edge with black on the left and white on the right as shown in FIG. 15 scrolls left to right.

The graphs in FIGS. 16, 17 show that the respective curves of RGB do not coincide with one another, but respond sequentially. In this case, the display confirms the sequential order of R, G, B. Since each of the RGB colors responds sequentially in a step-like manner, the edge part is seen colored to human eye as shown in FIGS. 14 and 15.

Therefore, similarly to the case of PDP, a color complementary to the color appearing at the edge part is added to the edge of the moving picture.

In the case of FIG. 16, first, red appears at the edge part, then green and blue sequentially join. Therefore, when red appears, green, which is the complementary color to red, and blue are added to the edge part. When green joins after red, only blue is added to the edge part.

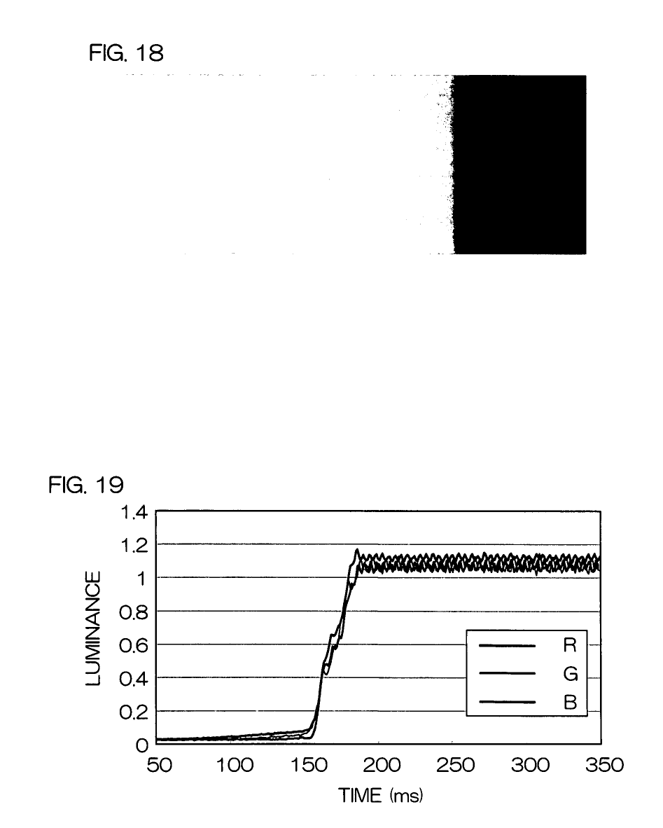

A pursuit-captured color moving picture image after adding the complementary color is shown in FIG. 18, and moving picture response curves in this case are shown in FIG. 19. As FIG. 19 shows, the moving picture response curves of the respective colors coincide with one another. Actually, the color at the edge disappears as shown in FIG. 18.

Likewise, in the case of the white-to-black edge in FIG. 17, blue appears first at the edge part, and then green and red sequentially join. Therefore, when blue appears, the complementary color red and green are added to the edge part. When green appears after blue, only red is added to the edge part.

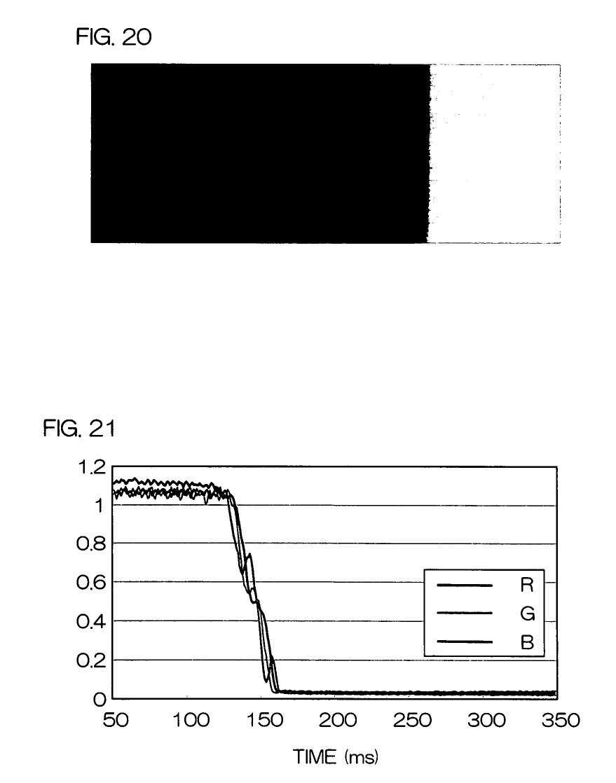

A pursuit-captured color moving picture image after adding the complementary color is shown in FIG. 20, and moving picture response curves in this case are shown in FIG. 21. Since the moving picture response curves of the respective colors coincide as shown in FIG. 21, the color at the edge part disappears as seen in FIG. 20.

Since the technique used herein is based on a control by one frame (the whole one field) of the image signals as in the case of PDP, it is applicable to all kinds of field sequential drive displays.

The present application corresponds to the Japanese Patent Application No. 2006-086479 filed with the Japanese Patent Office on Mar. 27, 2006, the disclosure of which is herein incorporated by reference.

1. A process for improving moving picture quality of a color display for displaying an image by light emission of display elements of a plurality of colors, the process comprising the steps of:
(a) obtaining at least an image signal corresponding to a moving area of an image from image signals for displaying a moving picture on a color display;
(b) adding a color for eliminating color breakup at an edge part of the moving picture corresponding to the obtained image signal; and
(c) feeding an image signal where the color for eliminating the color breakup at the edge part is added to the color display.

2. The process for improving moving picture quality of a color display according to claim 1, wherein in the step (b), the color for eliminating the color breakup at the edge part is specified using a moving picture response curve of each color component corresponding to the displayed edge part of the moving picture on the color display.

3. The process for improving moving picture quality of a color display according to claim 2, wherein when the edge is an edge that temporally moves from an area having a smaller luminance to an area having a greater luminance, the color for eliminating the color breakup at the edge is a color of a display element having a relatively long moving picture response time.

4. The process for improving moving picture quality of a color display according to claim 2, wherein when the edge is an edge that temporally moves from an area having a greater luminance to an area having a smaller luminance, the color for eliminating the color breakup at the edge is a color of a display element having a relatively short moving picture response time.

5. The process for improving moving picture quality of a color display according to claim 1, wherein the color display is a display adapted to cause the display elements of a plurality of colors to emit light sequentially color by color.

6. The process for improving moving picture quality of a color display according to claim 5, wherein when the edge is an edge that temporally moves from an area having a smaller luminance to an area having a greater luminance, the color for eliminating the color breakup at the edge is a color of a display element that appears relatively late in the order of appearance.

7. The process for improving moving picture quality of a color display according to claim 5, wherein when the edge is an edge that temporally moves from an area having a greater luminance to an area having a smaller luminance, the color for eliminating the color breakup at the edge is a color of a display element that appears relatively early in the order of appearance.

8. A program for improving moving picture quality of a color display for displaying an image by light emission of display elements of a plurality of colors, the program comprising the steps of:
obtaining at least an image signal associated with a moving area of an image from image signals for displaying a moving picture on the color display;
adding a color for eliminating color breakup at an edge part of the moving image corresponding to the obtained image signal; and
feeding an image signal where the color for eliminating the color breakup at the edge is added to the color display.
